(19) United States
(12) Patent Application Publication
(10) Pub. No.: US 2025/0354410 A1
(43) Pub. Date: Nov. 20, 2025

(54) LOCKING ACTUATOR HANDLE

(71) Applicant: Yakima Products, Inc., Lake Oswego, OR (US)

(72) Inventors: Brandon Michael Willems, Portland, OR (US); Jonathan Herinckx, Beaverton, OR (US); David Condon, Beaverton, OR (US)

(73) Assignee: Yakima Products, Inc., Lake Oswego, OR (US)

(21) Appl. No.: 19/213,195

(22) Filed: May 20, 2025

Related U.S. Application Data
(60) Provisional application No. 63/649,695, filed on May 20, 2024.

(51) Int. Cl. E05B 13/10; B60R 9/06; G05G 1/08; G05G 5/28

(52) U.S. Cl. CPC E05B 13/10; B60R 9/06; G05G 1/082; G05G 5/28; G05G 2505/00

(57) ABSTRACT

An actuator assembly, including a shaft defining a rotational axis, and a handle. The handle includes a manually rotatable handle body enclosing a transmission structure, a shuttle, and a lock assembly. The transmission structure is rotationally fixed to the shaft and has one or more openings. The shuttle is spring biased toward engagement with the openings. The lock assembly is operable to transition the handle between a locked mode and an unlocked mode. In the locked mode the handle body is rotatable independent of the shaft, and in the unlocked mode the rotation of the handle body results in rotation of the shaft.

### CROSS-REFERENCE TO RELATED APPLICATIONS

This application claims the benefit under 35 U.S.C. § 119 (e) of the priority of U.S. Provisional Patent Application Ser. No. 63/649,695, filed May 20, 2024, the entirety of which is hereby incorporated by reference for all purposes.

### BACKGROUND

Hitch mounts are common features of recreational equipment racks for vehicles, such as bike racks. Often, a stinger or tongue of the rack is received in a tubular hitch receiver of the vehicle. Some stingers are designed to be secured by a perpendicular hitch bolt. Others offer convenience and ease of use by incorporating a securing mechanism, such as an extendable shoe which can be brought into frictional engagement with an interior surface of the hitch receiver.

Such mechanisms may be actuated by use of a handle at a distal end of the stinger and/or at the rear of the attached rack. To prevent theft and accidental disengagement, the handle may include a locking feature. However, in-line locking features may require the handle to be in a specific position or orientation before the lock can be engaged, for instance by turning a key. A compact, easy-to-use actuator handle that allows locking and unlocking in any position is desirable.

### SUMMARY

The present disclosure provides systems, apparatus, and methods relating to actuator assemblies and actuator handles with a position-agnostic locking function. In some examples, an actuator assembly may include a shaft defining a rotational axis, and handle. The handle may include a manually rotatable handle body enclosing a transmission structure, a shuttle, and a lock assembly. The transmission structure may be rotationally fixed to the shaft, and have one or more openings. The shuttle may be spring biased toward engagement with the openings. The lock assembly may be operable to transition the handle between a locked mode and an unlocked mode. The handle body may be rotatable independent of the shaft in the locked mode, and the rotation of the handle body may result in rotation of the shaft in the unlocked mode.

In some examples, a locking handle for an actuator may include an exterior portion, a sleeve, a lock assembly, a shuttle, and a transmission structure. The exterior portion may be manually rotatable about a central axis and may be rotationally engaged with the sleeve. The lock assembly may be in an axial channel of the sleeve, and the shuttle may be at least partially disposed in a radial slot of the sleeve. The lock assembly may include a projection extending into the radial slot, and the shuttle may have a recess receiving the projection. The transmission structure may be rotationally engaged with the actuator and have a plurality of openings. Each opening may be shaped to receive an end portion of the shuttle, and the shuttle may be biased to move radially outward from the sleeve.

In some examples, a method of using an actuator handle may include operating a lock assembly in a handle body to rotate a projection of the lock assembly out of contact with a shuttle, and allowing a bias element to urge the shuttle radially outward into an opening in a surrounding transmission structure. The method may further include rotating the handle body to rotate the shuttle and the transmission structure.

Features, functions, and advantages may be achieved independently in various examples of the present disclosure, or may be combined in yet other examples, further details of which can be seen with reference to the following description and drawings.

### BRIEF DESCRIPTION OF DRAWINGS

FIG. 1 is an isometric view of a hitch mount including an illustrative locking actuator handle in accordance with aspects of the present disclosure.

FIG. 2 is an exploded isometric view of the handle of FIG. 1.

FIG. 3 is a cutaway isometric view of the handle of FIG. 1 in a locked mode, as indicated by line 3,4.

FIG. 4 is a cutaway isometric view of the handle of FIG. 1 in an unlocked mode, as indicated by line 3,4.

FIG. 5 is a cutaway isometric view of the handle of FIG. 1 in the locked mode, as indicated by line 5.

FIG. 6 is a cutaway isometric view of the handle of FIG. 1 in the locked mode, as indicated by line 6.

FIG. 7 is a cutaway isometric view of the handle of FIG. 1 in the locked mode, as indicated by line 7.

FIG. 8 is a cutaway isometric view of the handle of FIG. 1 in the locked mode, as indicated by line 8.

FIG. 9 is an exploded view of the lock sleeve, lock core, and shuttle body of the handle of FIG. 1, as indicated by line 9.

FIG. 10 is a side elevation view of the lock sleeve, lock core, shuttle body, and transmission gear of the handle of FIG. 1.

FIG. 11 is an axial view of the transmission gear, lock sleeve, lock core, and shuttle body of the handle of FIG. 1, with the lock core and shuttle body in a locked mode, cut away along line 11, 12, 13.

FIG. 12 is an axial view of the transmission gear, lock sleeve, lock core, and shuttle body of the handle of FIG. 1, with the lock core and shuttle body in an unlocked, but disengaged mode, cut away along line 11, 12, 13.

FIG. 13 an axial view of the transmission gear, lock sleeve, lock core, and shuttle body of the handle of FIG. 1, with the lock core and shuttle body in an unlocked and engaged mode, cut away along line 11, 12, 13.

FIG. 14 is a flow chart depicting steps of an illustrative method of securing a rack to a vehicle hitch receiver, including unlocking and using an actuator handle according to the present teachings.

### DETAILED DESCRIPTION

Various aspects and examples of a locking actuator handle, are described below and illustrated in the associated drawings. Unless otherwise specified, a handle in accordance with the present teachings, and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed examples. The following description of various examples is merely illustrative in nature and is in no way intended to limit the disclosure, its application, or uses. Additionally, the advantages provided by the examples described below are illustrative in nature and not all examples provide the same advantages or the same degree of advantages.

This Detailed Description includes the following sections, which follow immediately below: (1) Definitions; (2) Overview; (3) Examples, Components, and Alternatives; (4) Illustrative Combinations and Additional Examples; (5) Advantages, Features, and Benefits; and (6) Conclusion. The Examples, Components, and Alternatives section is further divided into subsections A and B, each of which is labeled accordingly.

### Definitions

Technical terms used in this disclosure have the meanings that are commonly recognized by those skilled in the art. However, the following terms may have additional meanings, as described below.

Substantially—predominantly conforming to the particular dimension, range, shape, concept, or other aspect modified by the term, such that a feature or component need not conform exactly, so long as it is suitable for its intended purpose or function. For example, a “substantially cylindrical” object means that the object resembles a cylinder, but may have one or more deviations from a true cylinder.

Approximately—when referring to a measurable value such as a parameter, an amount, a temporal duration, and the like, encompasses variations of +/−10% or less, preferably +/−5% or less, more preferably +/−1% or less, and still more preferably +/−0.1% or less of the specified value, insofar as such variations are appropriate to perform in the disclosure. It is to be understood that the value to which the modifier “approximately” refers is itself also specifically, and preferably, disclosed.

Actuator-a mechanical linkage or similar structure used to initiate, sustain, or otherwise act on motion of a mechanism. The term “actuator” may encompass a user-interface or interactable element such as a button or handle, or may be limited to structures connected to such an interface.

Lock—a mechanical, electronic, and/or magnetic mechanism used to selectively prevent access, arrest motion, and/or otherwise alter state on application of a specific item or condition such as a key or code.

Handle—a user interface facilitating manual application of force. A handle may be fixed or movable, and may facilitate application of rotational and/or linear force. The term ‘handle’ may encompass round structures described as knobs, elongate structures described as levers, looped structures described as pulls, and/or any effective shapes. The term ‘handle’ may be limited to the surfaces or structure(s) contacted by a user's hand, or may encompass additional structures and/or mechanisms used in transferring the manually applied force.

The various structural members disclosed herein may be constructed from any suitable material, or combination of materials, such as metal, plastic, rubber, or any other materials with sufficient structural strength to withstand the loads incurred during use. Materials may be selected based on their durability, flexibility, weight, and/or aesthetic qualities.

### Overview

In general, a position-agnostic locking actuator handle may be described as comprising 3 domains: a user domain, an actuator domain, and a connection domain. Each domain may comprise multiple parts fastened together, in contact, and/or otherwise engaged. All parts of the user domain may be engaged to rotate together, and similarly all parts of the actuator domain may be engaged to rotate together.

The user and actuator domains may rotate independently unless rotationally engaged through the connection domain. One or more parts of the connection domain may move axially, laterally, and/or radially to link the user and actuator domains. Parts of the connection domain may be acted on by a lock assembly to initiate movement. Rotational engagement between the user and actuator domains may be described as an unlocked mode, and disengagement may be described as a locked mode.

The lock assembly may be part of the user domain, the actuator domain, or the connection domain. In some examples, the connection domain may rotate with the user domain in the locked mode. In other examples, the connection domain may rotate with the actuator domain in the locked mode. In other examples, the connection domain may not rotate in the locked mode.

Such an actuator handle may include a transmission structure comprising a pair of engagable elements: a translatable element and a rotatable element. In the locked mode the elements of the transmission structure may be disengaged, and in the unlocked mode the elements of the transmission structure may be engaged.

A lock assembly of the actuator handle may allow or prevent movement of and/or move the translatable element, to lock and unlock the actuator handle by causing engagement or disengagement of the transmission structure elements. The lock assembly may operate by key, code, sensor, or any effective mechanism, and may include translational and/or rotational motion in the transition between locked and unlocked states.

The rotatable element may be rotationally engaged with or fixed to a rotating member of an actuation mechanism. The rotatable element may also include one or more apertures, slots, openings, recesses, and/or other structures configured to receive at least a portion of the translatable element. The translatable element may be biased to translate toward the receiving structures of the rotatable element.

The actuator handle may further include an outer manual grip, housing, exterior portion, and/or other means of manual rotation. The actuator handle may also be described as a knob or handgrip, and may be used with any mechanism actuated by rotation of some member. For example, a locking actuator handle may be incorporated into the hitch mount tightening mechanism of a hitch rack for bicycles.

In some examples, the rotatable element may at least partially surround the translatable element, which may be biased to move radially outward. In some examples, the translatable element may be rotatable around the rotatable element, and may be biased to move radially inward. The translatable element may be spring biased, magnetically attracted, and/or urged to default movement in the relevant direction by any effective bias element or other means.

The locking actuator handle may be described as having position-agnostic locking. Existing locking handles may require a user to rotate the handle to a specific orientation, to allow a lock core to turn a cylinder. An actuator handle with position agnostic locking as described herein may allow locking and unlocking in any position. When locked, the handle may spin free of engagement with the rest of the actuation mechanism. When unlocked, the translatable element may find one of the apertures of the rotatable element as the handle is rotated. Once the translatable element is received in an aperture, the handle may engage the actuating mechanism as a user continues rotation of the handle.

A locking actuator handle as described herein may also have minimal diameter requirements. That is, the handle may be smaller in diameter than existing handles. Such a smaller diameter may allow for greater torque output from a user, for faster or more effective actuation.

### Examples, Components, and Alternatives

The following sections describe selected aspects of exemplary locking actuator handles as well as related systems and/or methods. The examples in these sections are intended for illustration and should not be interpreted as limiting the entire scope of the present disclosure. Each section may include one or more distinct examples, and/or contextual or related information, function, and/or structure.

### A. Illustrative Stinger Knob

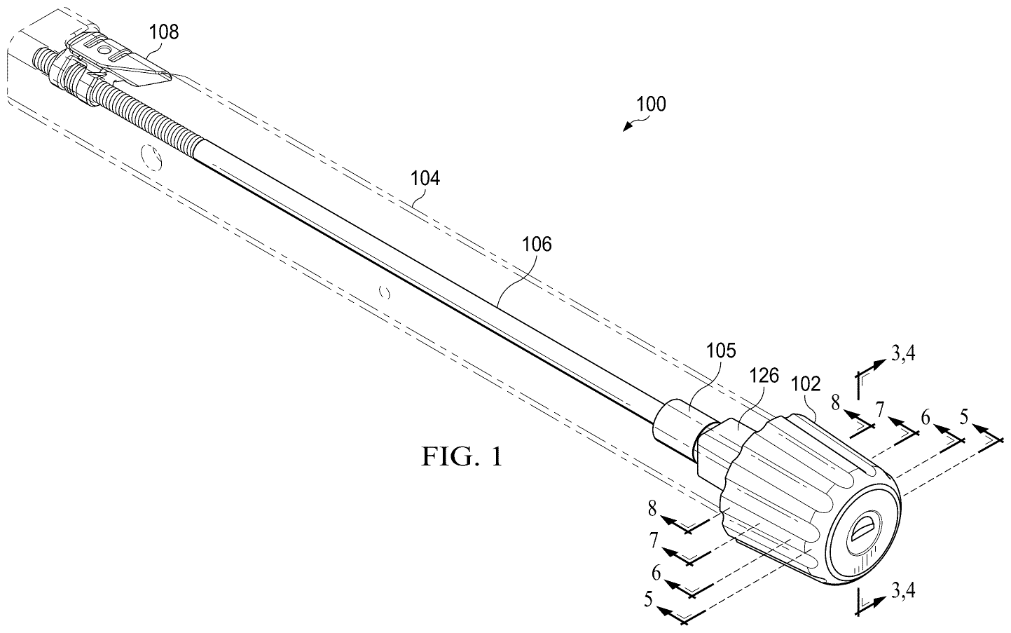

As shown in FIGS. 1-13, this section describes an illustrative hitch mount 100 for a bicycle rack, including an actuator assembly with a locking knob 102. Knob 102 is an example of a position-agnostic locking actuator handle, as described above.

Hitch mount 100 may be part of a vehicle rack such as a bicycle carrier, to facilitate mounting of the rack to a vehicle hitch. In the present example, the hitch mount includes a stinger 104, for insertion into a hitch receiver. The actuator assembly may allow a user to secure the stinger in the hitch receiver from behind the rack, at a distal end of the stinger.

The actuator assembly may include a rotating shaft or member, a securing structure, and a handle. In the present example the assembly includes a bolt 106, a shoe 108, and knob 102. In FIG. 1, stinger 104 is shown as transparent in order to depict bolt 106. Bolt 106 is engaged with knob 102 at a proximal end and engaged with shoe 108 at a distal end. As bolt 106 is tightened using knob 102, shoe 108 may extend to engage the inner surface of a hitch receiver.

Stinger 104 includes a substantially rectangular tube with a side opening at a distal end for shoe 108, and an open proximal end. An endcap 126, partially received in the hollow tube, occludes the distal end. Bolt 106 extends from knob 102 through endcap 126 and the hollow interior of stinger 104 to engage shoe 108.

Bolt 106 is an example of a rotating member of an actuation mechanism as described above. Knob 102 as described below may also be used with similar rotating members for other actuation mechanisms, including but not limited to bicycle racks or hitch-mounted equipment.

Knob 102 is configured to allow a user to tighten or loosen bolt 106, thereby securing or releasing the hitch mount from the vehicle's hitch receiver. The knob may be described as having a locked mode and an unlocked mode. In the locked mode, elements of knob 102 may spin freely without turning bolt 106. In the unlocked mode, rotation of knob 102 may cause rotation of bolt 106.

Knob 102 is described below in a reference frame of a user of hitch mount 100, positioned at the distal end of stinger 104, facing the knob. Paired terms ‘proximal-distal’ and ‘front—rear’ or similar language may be used to describe components, spatial relationships, and/or directions. Proximal or front may describe aspects closer to the user, and distal or rear may describe aspects further from the user.

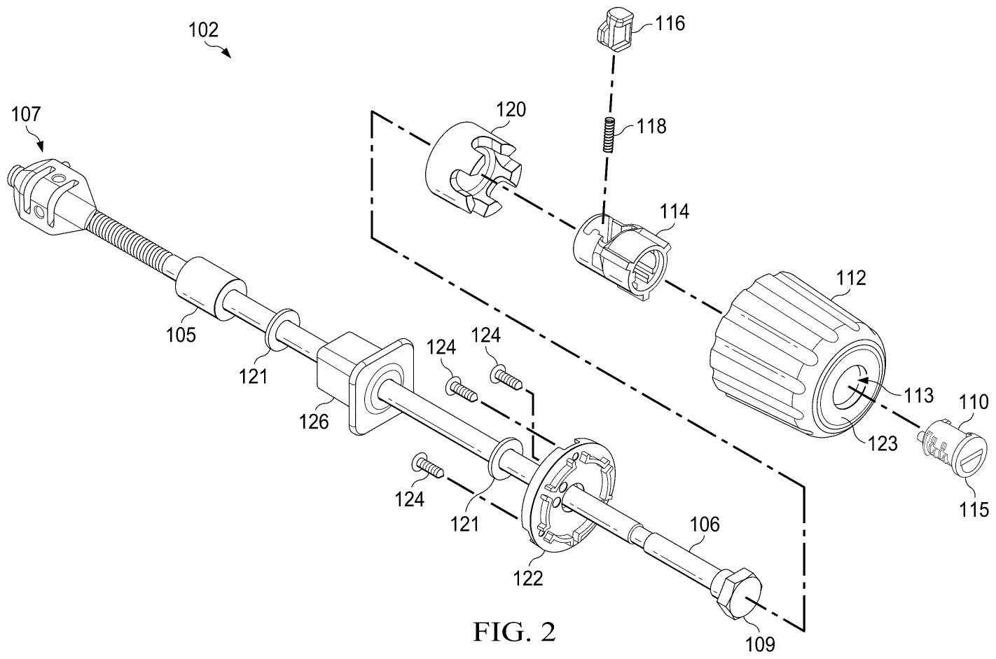

FIG. 2 is an exploded view of knob 102. Also shown are bolt 106, endcap 126, a fitting 105, and washers 121 of the actuator assembly. Fitting 105 may engage a recess or narrow section of bolt 106 to maintain appropriate relative positioning of bolt 106, endcap 126 and the stinger tube. Washers 121 may be conformable or resilient material and/or may be configured to facilitate smooth rotation between fitting 105 and endcap 126, and the endcap and knob 102.

At a distal end, bolt 106 has a threaded end portion 107 to engage the hitch mount shoe. At a proximal end, the bolt has a hexagonal head 109 to engage locking knob 102. In some examples, the knob and/or bolt may rotate on a bearing or other means of smooth rotation.

Knob 102 includes a lock assembly 110, a handle body with an outer grip 112 and a main casing 123, a core sleeve 114, a shuttle 116, a spring 118, a transmission crown 120, a rear casing 122, and screws 124. Bolt 106 extends through a central aperture of rear casing 122, with head 109 on a proximal side of the read casing. Main casing 123 includes a proximal opening 113 to expose a front face 115 of lock assembly 110. The front face of the lock assembly may accept a key, for locking and unlocking of knob 102.

The lock assembly, handle body, core sleeve, transmission crown, and rear casing are all aligned with and centered on a shared rotational axis defined by bolt 106. The rotational axis may also be referred to as a longitudinal axis of the bolt. Elements of knob 102 may be described as inner or outer, inward or outward relative to the rotational axis of the bolt.

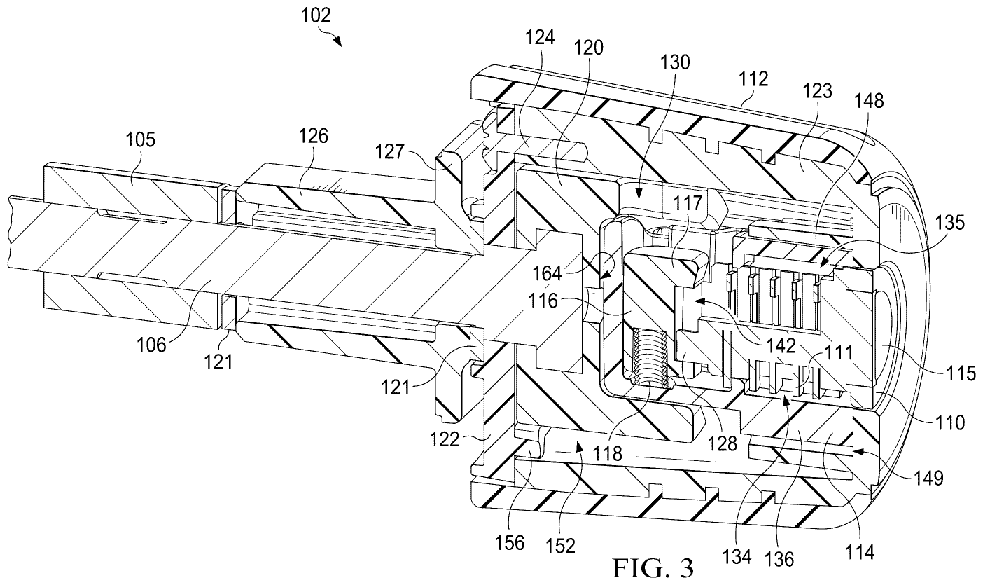

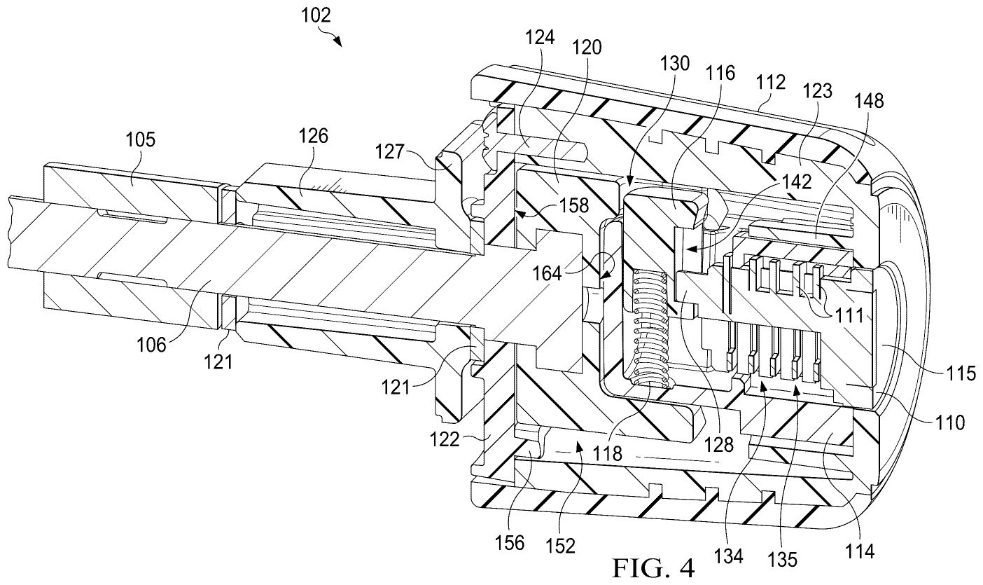

As shown in FIGS. 3-4, rear casing 122 is fixed to main casing 123 by screws 124 to form an enclosure around core sleeve 114, shuttle 116, spring 118, and transmission crown 120. Casings 122, 123 may also be referred to as a housing and/or in combination with outer grip 112 as a housing, handle body, handle portion, or exterior portion of knob 102.

Rear casing 122 is close against endcap 126, and a square flange 127 of the endcap may render screws 124 inaccessible when the hitch mount is assembled, preventing access to the interior of knob 102 by removal of the rear casing.

Transmission crown 120 is molded over the hexagonal head of bolt 106 and thereby rotationally fixed to the bolt. The crown may also be described as an adaptor, receiver, transmitting wheel or crown gear, Transmission crown 120 includes a plurality of axial projections which may be referred to as teeth 132, surrounding a central flat face 164. Core sleeve 114 is partially received between teeth 132, with a distal wall 162 of the sleeve proximate but spaced from face 164 of the crown.

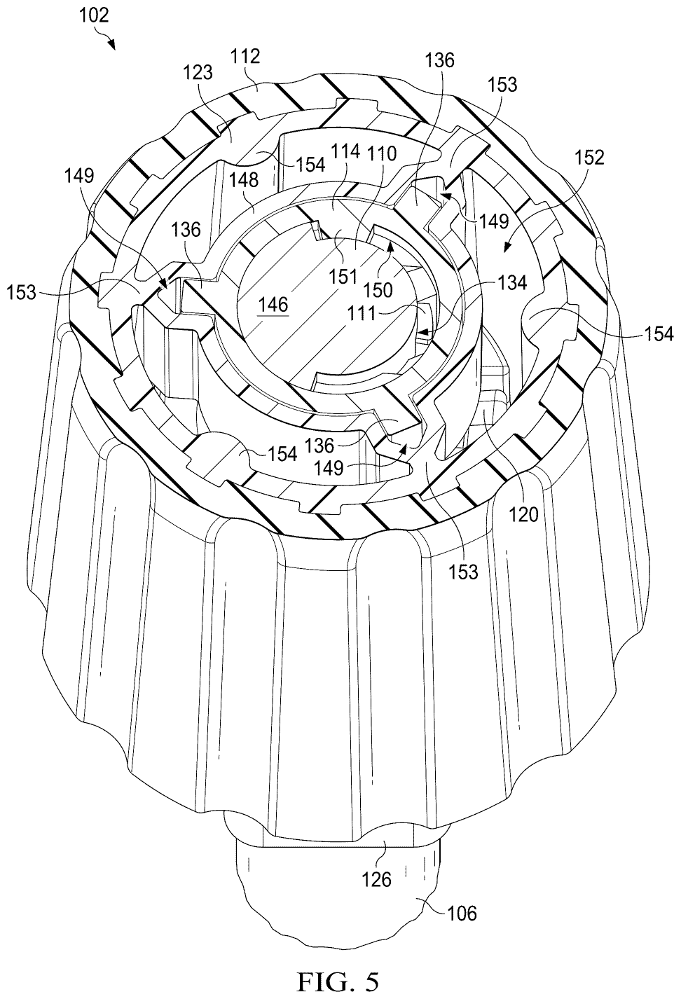

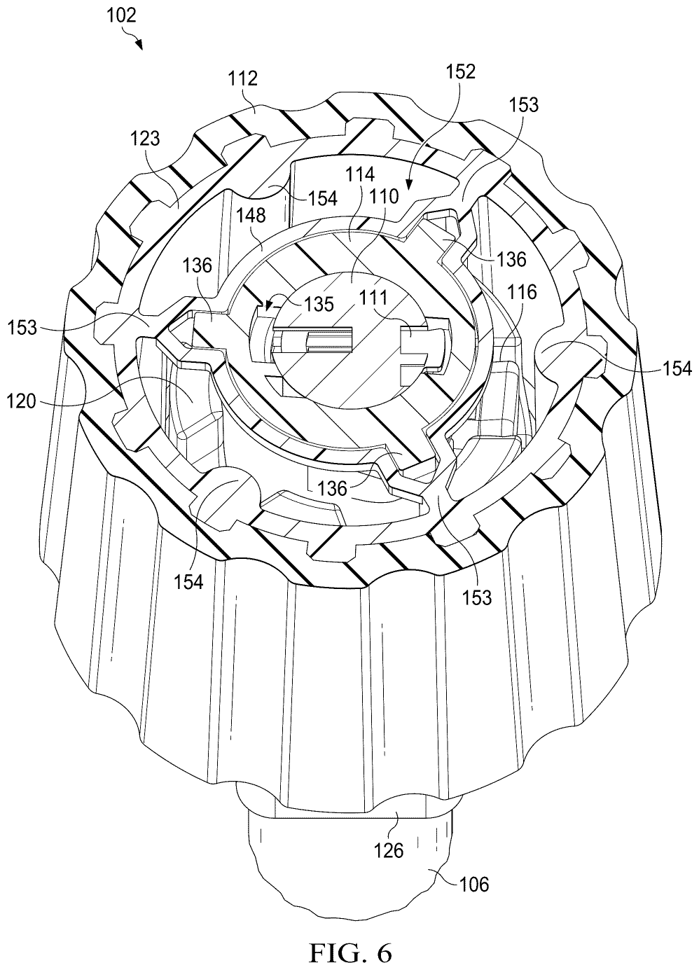

Lock assembly 110 is received in main casing 123, but accessible through proximal opening 113. Front face 115 may fill opening 113, preventing access to the interior of knob 102 through the opening. The lock assembly extends from opening 113 through core sleeve 114 to interact with shuttle 116. Sleeve 114 is shaped to engage and accommodate lock assembly 110, as described in more detail with reference to FIGS. 5-6. The sleeve includes axially extending spaces 135 to accommodate protruding tumble structures 111. The sleeve may be over molded onto the lock assembly to prevent removal or disengagement and/or facilitate the desired interlocking spatial relationship.

Elements of knob 102 may be described as axially fixed. That is, lock assembly 110, core sleeve 114, shuttle 116, and crown 120 may be mounted in casings 122, 123 such that no relative motion is allowed parallel the rotational axis of bolt 106. Rotational and radial movement are dependent on the mode of knob 102.

Knob 102 may be described in terms of the 3-domains discussed above. Under such division, lock assembly 110, outer grip 112, main casing 123, core sleeve 114, and rear casing 122 may be described as forming the user domain. Shuttle 116 and spring 118 may form the connection domain, and transmission crown 120 may be the actuator domain. A user may interact with knob 102 by turning outer grip 112 or by using a key in lock assembly 110. To a user ‘turning the knob’ may consist of rotating outer grip 112, the effect of which will depend on the rotational engagement of other elements. Bolt 106 may be rotated only by engagement with transmission crown 120.

In FIG. 3, knob 102 is shown in the locked mode. In FIG. 4, the knob is shown in the unlocked mode. In both modes, core sleeve 114 and shuttle 116 are rotationally engaged with main casing 123, and rotate as a user turns knob 102. A main body portion of lock assembly 110 is in turn rotationally engaged with core sleeve 114. In the locked mode, transmission crown 120 and bolt 106 are not rotationally engaged with the outer casing, and will not turn when the user turns knob 102. In the unlocked mode, the crown and bolt are rotationally engaged with the outer casing, and will turn when the user turns the knob.

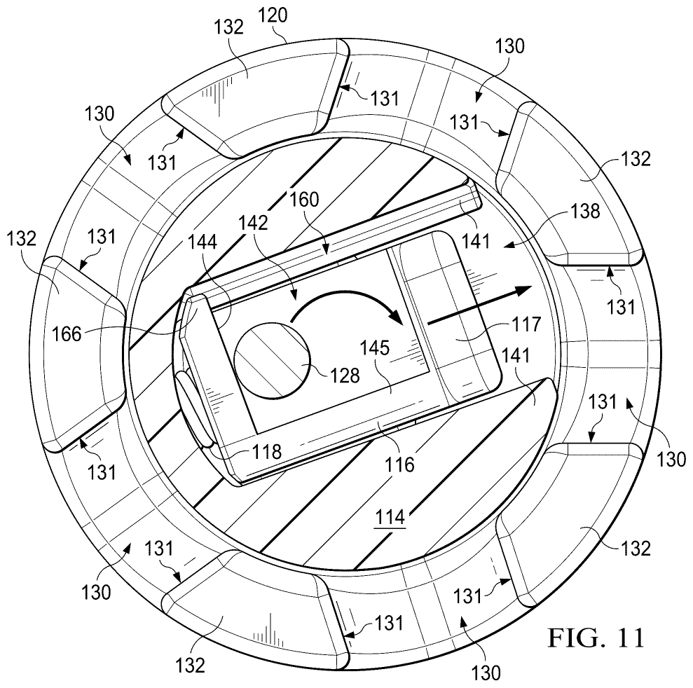

Lock assembly 110 further includes an axially extending projection, or pin 128. Pin 128 is independently rotatable. That is, the pin can be rotated around a central axis of the lock assembly by a user turning a key in the lock assembly. Pin 128 may be described as having a locked position and an unlocked position, as discussed in greater detail with reference to FIGS. 11-13, below.

Shuttle 116 includes an aperture to receive a first end of spring 118. A second end of the spring is pressed against an interior surface of core sleeve 114. Shuttle 116 is biased by spring 118 to move out of core sleeve 114, and into one of a plurality of apertures or recesses 130 between teeth 132 of transmission crown 120. The shuttle may be described as having an engaged position and a disengaged position, as discussed in greater detail with reference to FIGS. 11-13, below.

In the disengaged position, as shown in FIG. 3, an outer portion 117 of shuttle 116 is received in a recess 130 between teeth 132 of transmission crown 120. When outer grip 112 is rotated by a user, the resulting rotation of shuttle 116 and engagement between the shuttle and crown teeth may cause rotation of the crown. The crown may in turn rotate bolt 106.

In the engaged position, as shown in FIG. 4, shuttle 116 is fully received in core sleeve 114. Sleeve 114 may therefore freely rotate without the shuttle contacting the crown. When outer grip 112 is rotated by the user, crown 120 and bolt 106 may remain stationary.

Shuttle 116 and crown 120 are an example of a pair of engageable elements comprising a transmission structure. The shuttle may also be referred to as a translatable element, a shuttle body, a pin, or a carriage. Shuttle 116 may be described as radially and/or laterally translatable. More specifically, the shuttle may move in a plane perpendicular to the rotational axis of bolt 106. A central axis of the shuttle may intersect the rotational axis of the bolt.

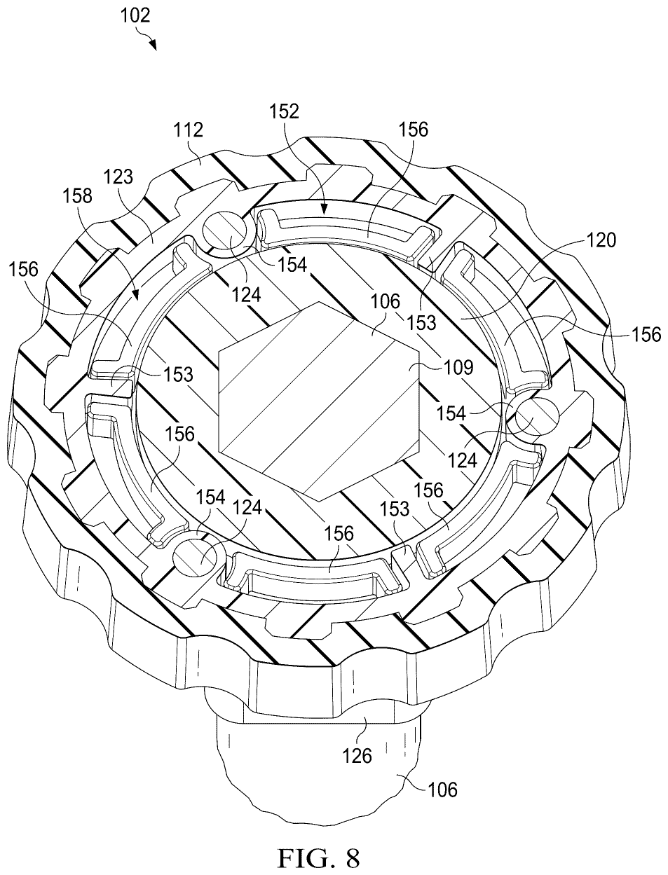

FIGS. 5-8 are isometric views of knob 102, cut away at four planes along the knob. Elements of the knob may be referred to as upward or downward, above or below in the reference frame of the figures. In this reference frame, upward corresponds to proximal a user and downward corresponds to distal from the user. FIG. 5 is cut away at the uppermost plane, moving down to FIG. 8 at the lowermost plane.

As shown in FIG. 5, outer grip 112 surrounds main casing 123. The main casing is keyed into an inner surface of the grip, and may also be adhesively bonded to the outer grip. In some examples, the outer grip may be a coating on main casing 123 or may comprise part of the main casing. In the present example, the outer grip is comprised of a resilient material with a high coefficient of friction, to provide a pleasant and effective manual grip. The outer grip is also ridged or knurled to improve user grip. In general, the outer grip and/or exterior portions of main casing 123 may have shape and/or comprise any material appropriate for user interaction.

Core sleeve 114 includes a plurality of exterior flanges or splines 136, configured to rotationally engage main casing 123. The sleeve may be described as in splined engagement with the handle body. In the present example, the sleeve includes three splines. In general, the sleeve may include any number of splines and/or any feature appropriate to transfer rotation between the outer casing and the sleeve. In some examples, sleeve 114 may be fastened or adhesively bonded to main casing 123.

In the depicted example, main casing 123 includes a central ring 148 disposed in an interior space 152 the casing. Three spline-receiving recesses 149 are spaced around the ring. Each recess 149 of central ring 148 receives a spline 136 of sleeve 114. At each recess, central ring 148 contacts and is joined with an outer wall of main casing 123. Main casing 123 is generally frusticonical, with interior space 152 and outer grip 112 increasing in diameter from top to bottom, while central ring 148 remains a fixed diameter.

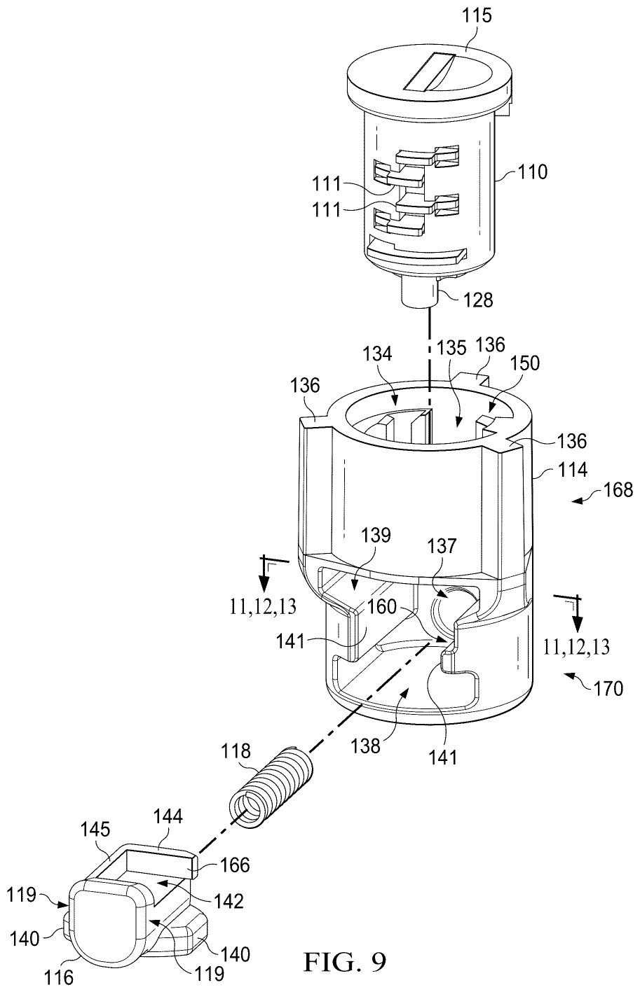

The main body portion of lock assembly 110 extends through an axial channel 134 of sleeve 114 (see FIG. 9). In FIG. 5, a semi-annular flange 146 of the lock assembly is shown received in a semi-annular space 150 at the top of the channel. Channel 134 of sleeve 114 may also be described as having an increased diameter at a top end, with a stop 151 protruding into the channel. Flange 146 has a smaller angular extent than space 150, allowing a range of positions in the channel limited by contact between flange 146 and stop 151.

As shown in FIG. 6, channel 134 further includes two opposing, axially-extending spaces 135 to accommodate protruding tumbler structures 111 of lock assembly 110. The tumbler structures may move between spaces 135 on operation of lock assembly 110 by a key, but may be accommodated by sleeve 114 in locked and unlocked positions.

In general, core sleeve 114 may be configured to conform to and accommodate any lock assembly of knob 102. The sleeve may include any spaces, channels, openings, stops, or protrusions appropriate to allow operation of the lock assembly while rotationally engaging the lock assembly to transfer rotation of main casing 123 to the lock assembly.

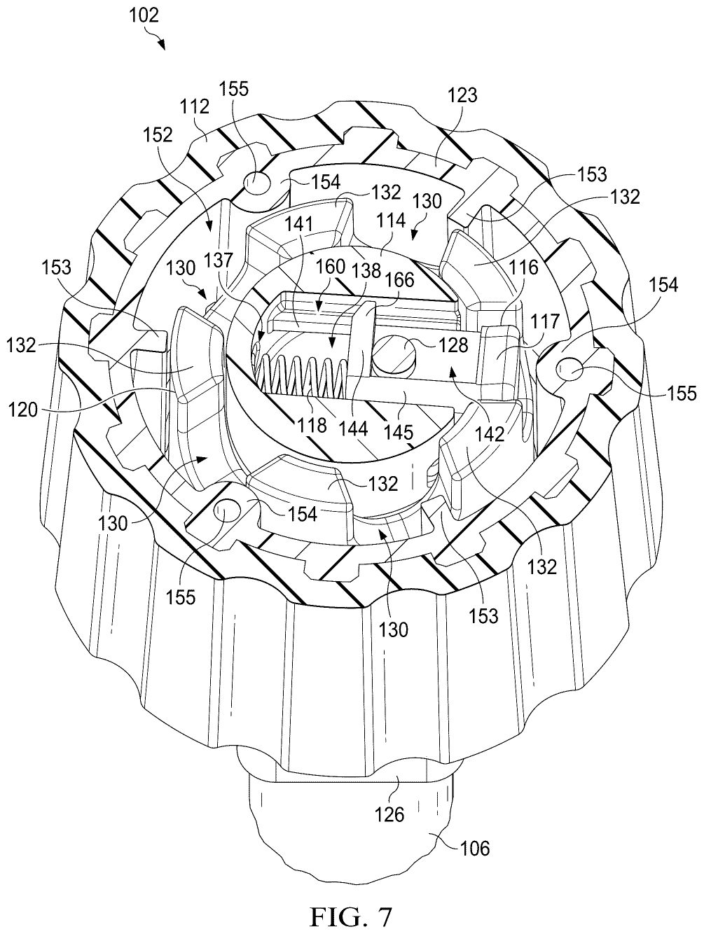

A bottom end of central ring 148 can be seen in FIG. 6, vertically spaced from teeth 132 of transmission crown 120. Where the central ring connects to the outer wall of main casing 123, interior splines 153 continue down the outer wall of the main casing. Also extending from the outer wall of main casing 123 are three rounded ribs 154. As can be seen in FIGS. 7 and 8, rounded ribs 154 each define a screw hole 155 to engage one of screws 124.

As can be seen in FIG. 7, in the views of FIGS. 5-8 knob 102 is the unlocked mode. Shuttle 116 is in the engaged position with outer portion 117 extending between two teeth 132 of transmission crown 120.

In the present example, transmission crown 120 includes five teeth 132 and five recesses 130. The teeth and recesses have approximately equal angular extent, but are of different shape, as discussed further with reference to FIG. 11. Sleeve 114 is closely fitted in the center of all five teeth, but spaced from crown 120. The sleeve may not contact the crown, to facilitate easy relative rotation when knob 102 is in the locked mode.

In general, the crown may have any number of teeth of any size. Preferably, the crown may include at least three recesses appropriate to receive shuttle 116. The greater the number of recesses, the smaller the angular distance between recesses, and the less rotational travel needed to align the shuttle with a nearest recess.

In FIG. 8, rear casing 122 and head 109 of bolt 106 can be seen. Transmission crown 120 includes a hexagonal cavity tightly conforming to the bolt head, rotationally fixing the crown to the bolt.

The rear casing includes a plurality of linear bosses 156, extending up between splines 153 and ribs 154 of main casing 123. The bosses may also be referred to as vertical protrusions or surface features on upper or proximal surface 158 of rear casing 122, and may align screw holes in the rear casing with holes 155 to allow installation of screws 124. In addition to screws 124, the bosses may also rotationally engage the rear casing with the main casing.

Transmission crown 120 is spaced from all elements of main casing 123, and rear casing 122, including in FIG. 8: splines 153, ribs 154, and bosses 156. As can be seen in FIGS. 3-4 the crown is also spaced from proximal surface 158 of the rear casing. Lack of contact between the crown and casings as a consequence of this spacing may allow the casings to rotate freely relative to the crown when the knob is in the locked mode.

Core sleeve 114 can be seen in more detail in FIG. 9. The sleeve is generally cylindrical, with an open proximal end and a closed distal end. The proximal end opens into to axial channel 134, which is configured to receive lock assembly 110, as discussed with reference to FIGS. 5-6 above. At the closed proximal end, core sleeve 114 includes a laterally or radially extending slot 138. That is, the sleeve includes an opening to substantially linear aperture that may be referred to as a lateral slot or a radial slot.

Slot 138 is open to axial channel 134. The slot may be described as closed at one end, or as not extending fully through core sleeve 114. At the closed end of slot 138, the sleeve includes a circular recess 137 to seat and/or retain spring 118 in position. Slot 138 is shaped to conform closely to shuttle 116, without impeding sliding of the shuttle in and out of the slot.

Core sleeve 114 may be described as having a proximal or upper half 168 and a distal or lower half 170. The upper half is generally cylindrical, including exterior splines 136 and configured to engage lock assembly 110. The lower half has a side opening 139 into slot 138 and a lowermost portion of channel 134, and is configured to engage shuttle 116. In the present example, the upper and lower halves 168, 170 have an equal outer diameter, with splines 136 tapering down the lower half.

In the present example, slot 138 may be described as T-shaped and/or as having an upper portion defined between opposing protruding walls 141. Walls 141 may be linear, extending across channel 134 and perpendicular to the rotational axis of knob 102 without intersecting that axis. That is, the walls may be described as lateral and not radial in extent. One of walls 141 includes a notch 160 on an upper side. The wall may also be described as L-shaped or cut-out. Below walls 141, a lower portion of slot 138 may be wider than the upper portion between the walls.

In the present example, shuttle 116 includes a pair of side flanges or wings 140 on laterally opposite sides, and a rectangular recess 142 on a proximal or upper face. The recess may be described as open on top and at one side. In other words, the recess is defined or enclosed by a rear wall 144 and a side wall 145 on the upper face of the shuttle. An asymmetric protrusion 166 extends out from rear wall 144 past recess 142.

When shuttle 116 is received in slot 138, walls 144, 145 and recess 142 may be disposed in the upper portion of the slot while wings 140 may be disposed in the lower portion of the slot. Asymmetric protrusion 166 may be received in notch 160. Walls 141 of the slot may restrict axial movement of wings 140. In the present example, wings 140 extend only partway along the shuttle to avoid interference with the transmission crown. The wings may be described as swept-back or beveled to complement an inner side of the crown teeth.

Wings 140 and protrusion 166 may stabilize and position shuttle 116 in slot 138. Shuttle 116 is spring-biased to move radially out of slot 138, but may remain at least partially received in the slot at all times. The shuttle may therefore rotate with core sleeve 114, and in the engaged position may transfer the rotation of the core sleeve to the transmission crown.

Rectangular recess 142 is configured to receive and engage pin 128 of lock assembly 110. The pin extends down through channel 134, into slot 138 and recess 142. Contact between pin 128 and shuttle 116 may transition the shuttle to, and retain the shuttle in, the disengaged position, as described further with reference to FIGS. 11-13.

In the present example, operation of lock assembly 110 rotates pin 128 around the main body of the assembly. In general the motion of pin 128 may be based on the properties of lock assembly 110. Pin 128 may undergo type of motion, including but not limited to translational or radial motion, as long as a line between locked and unlocked positions is rotated with shuttle 116 by sleeve 114. That is, as long as movement pin 128 remains in alignment with the orientation of shuttle 116.

In the present example, outer portion 117 of shuttle 116 has a generally rectangular shape, with a rounded lower surface and substantially flat side bearing faces 119. Edges of the outer portion are rounded to facilitate smooth engagement with the transmission crown.

In general, slot 138 may be shaped to conform to shuttle 116 and the shuttle may have any shape appropriate to facilitate translation in response to movement of pin 128 and transfer rotational motion to the transmission crown.

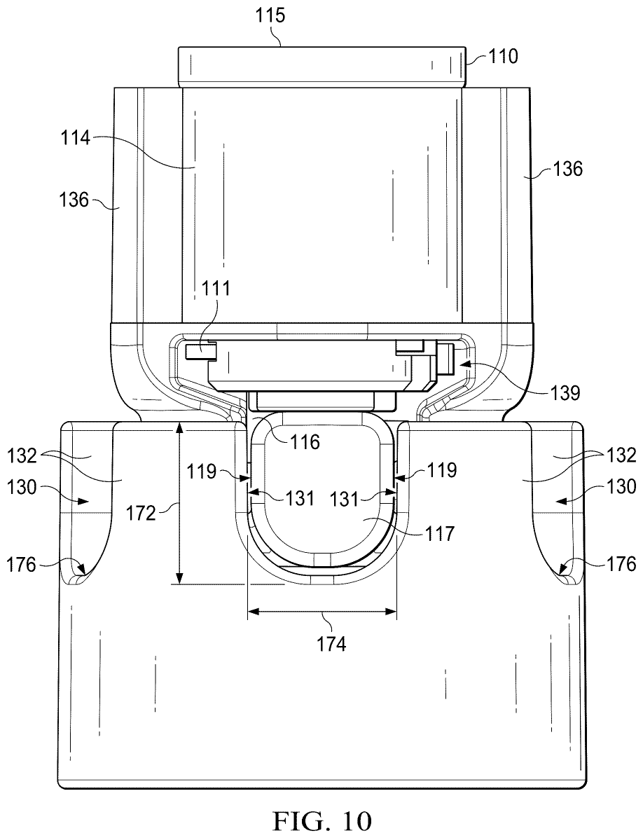

FIG. 10 is a side elevation view of lock assembly 110, core sleeve 114, shuttle 116, and transmission crown 120 assembled as in knob 102. The crown may be described as surrounding the lower half of core sleeve 114 and shuttle 116, and/or as including an axially extending circumferential flange surrounding the sleeve and shuttle. Shuttle 116 is shown engaged with a recess 130 of transmission crown 120. Outer portion 117 of the shuttle is shaped to closely correspond to recesses 130 of the crown, which are substantially identical to one another in shape and size. Each tooth 132 has a height 172 and is spaced from the next tooth by a distance 174. A top surface of each tooth is substantially flat, and a bottom surface 176 of each recess is substantially curved.

Each tooth has two side faces 131, configured to engage bearing faces 119 of shuttle 116. In the present example, side faces 131 and bearing faces 119 are each substantially flat. In some examples the faces may have some complementary shape. As shuttle 116 is rotated by sleeve 115, one of bearing faces 119 may contact an adjacent one of side faces 131. Rotational motion may be transferred to the transmission crown through such contact.

Faces 131, 119 may be described as laterally extending. That is, a plane defined by each face may not intersect the rotational axis of the knob. As can be seen in FIG. 11, the planes of side faces 131 of teeth 132 would not all intersect at a center point of transmission crown 120. More specifically, the proximate side faces of any two adjacent teeth are parallel one another. As a result, recesses 130 each have a constant width, allowing passage of shuttle 116.

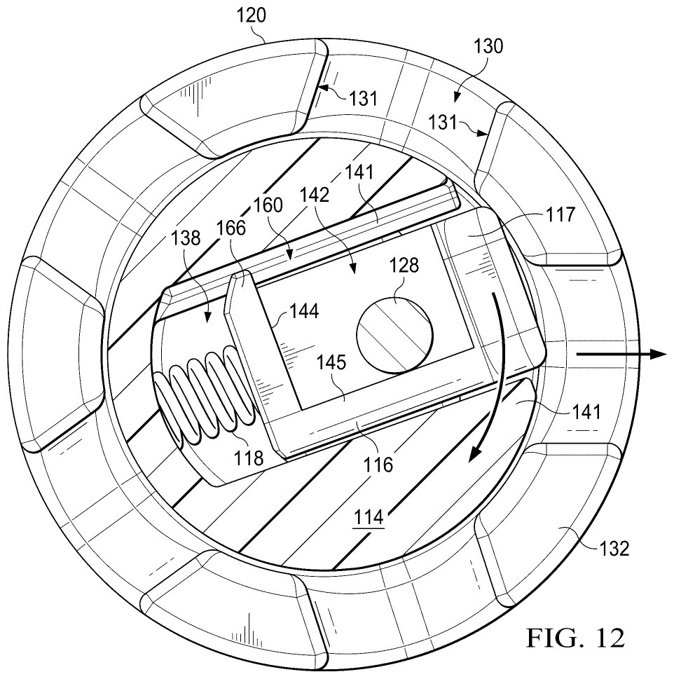

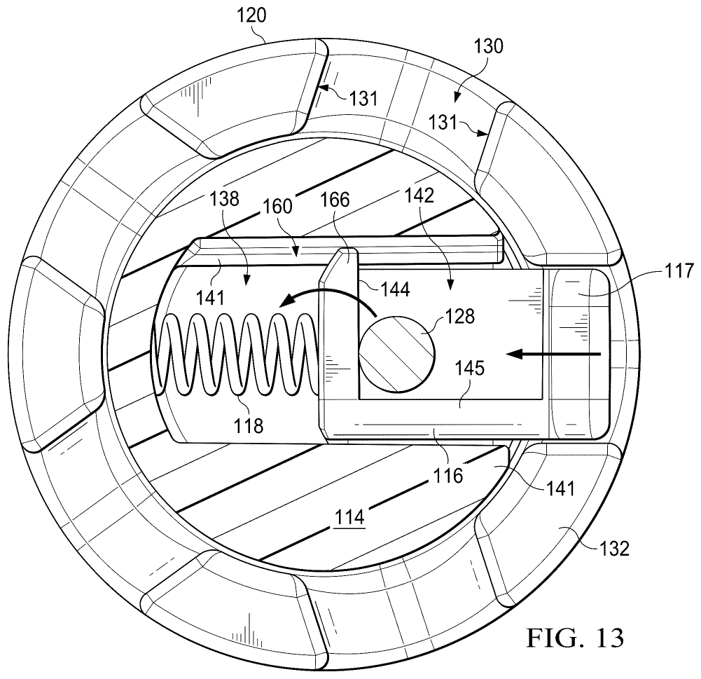

FIGS. 11-13 are detail views of transmission crown 120, core sleeve 114, shuttle 116, spring 118, and pin 128 of lock assembly 110, with the remainder of the lock assembly cut away for clarity. FIG. 11 shows the locked mode of knob 102, FIG. 12 shows a first stage of the unlocked mode of the knob, and FIG. 13 shows a second stage of the unlocked mode.

As shown in FIGS. 2 and 11-13 and discussed above, transmission crown 120 includes recesses 130, defined between projections 132. The crown may also be described as a crown gear with teeth 132, as having a circumferential flange with depressions or apertures 130, and/or as having a main body with a plurality of axially extending projections 132 spaced around the edge of a proximal side. In the present example, transmission crown 120 includes five recesses 130. The crown may additionally or alternatively have any shape and/or include any features appropriate to receive and engage shuttle 116.

In FIG. 11, knob 102 is locked. Pin 128 of the lock assembly is in the locked position, in contact with a rear wall 144 of recess 142 of shuttle 116. The shuttle is thereby held in slot 138 of core sleeve 114, against the bias of spring 118. As core sleeve 114 is rotated by a user's rotation of the outer casing, shuttle 116 may rotate in and out of alignment with recesses 130. However, knob 102 may be unlocked in any position, including the un-aligned position shown in FIG. 11. That is, a user may turn a key to unlock assembly 110, rotating pin 128, irrespective of the position of shuttle 116.

When the user unlocks the lock assembly, pin 128 is rotated as indicated by the arrow in FIG. 11, to the unlocked position shown in FIG. 12. As a result, shuttle 116 no longer resists the force of spring 118 and is pushed out of slot 138. As shown in FIG. 12, shuttle 116 stops against projection 132 of transmission crown 120, and the knob is unlocked but not yet engaged. With pin 128 in the unlocked position and shuttle 116 not engaged, the pin may not be in contact with the shuttle.

When the user begins turning knob 102 to actuate the hitch mount, the knob is brought into engagement, as shown in FIG. 13. That is, turning the knob rotates core sleeve 114 and shuttle 116, as indicated by the arrow in FIG. 12. At some point, the shuttle will align with one of recesses 130. Under the bias of spring 118, the shuttle is urged further out of slot 138, into that recess.

Shuttle 116 may be restrained from extending out past transmission crown 120 by pin 128 and/or by wings 140 (see FIG. 9). In some examples, each wing may contact one of the projections 132 adjacent the recess 130 in which a distal end portion of the shuttle is received. In the depicted example, pin 128 restrains shuttle 116 by contact with rear wall 144, when the pin is in the unlocked position and the shuttle is in the engaged position. In some examples, pin 128 may not contact shuttle 116 when in the unlocked position.

The user may continue turning the knob, and begin actuation. Shuttle 116, received in recess 130, engages one of the two adjacent projections 132, whichever way the knob is turned. Rotation of the handle body is therefore transferred through the transmission crown to the bolt.

Since the five recesses 130 are equally spaced around wheel 120, shuttle 116 may need to rotate at most about 70 degrees, or less than a quarter turn before engaging. The user may therefore experience minimal lag before the actuator knob ‘catches’.

Knob 102 may also be locked from any position. That is, a user may turn a key to lock assembly 110, rotating pin 128, irrespective of the position of shuttle 116. When the user locks the lock assembly, pin 128 is rotated as indicated by the arrow in FIG. 13, back to the locked position. As pin 128 rotates, the pin bears against rear wall 144 of recess 142 in shuttle 116. The pin may urge the shuttle back into slot 138, against the bias of spring 118. Pin 128 is positioned relative to shuttle 116 such that when the pin has returned to the locked position, the shuttle has been fully received into slot 138 and returned to the disengaged position. The outer casing may then freely rotate relative to the transmission crown and the bolt, again.

### B. Illustrative Method

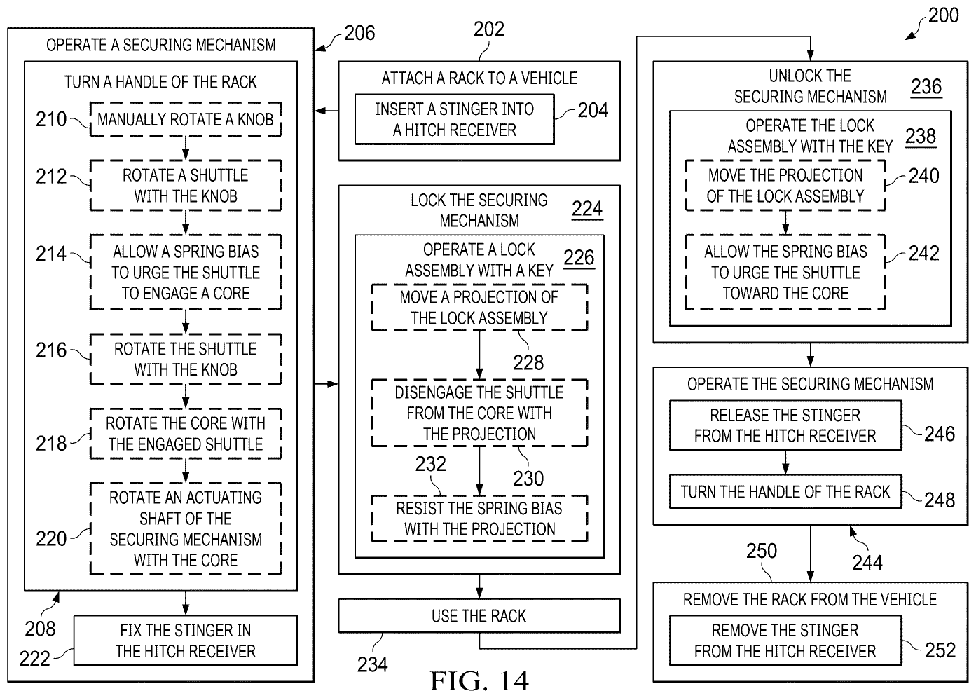

This section describes steps of an illustrative method 200 for securing a rack to a vehicle hitch receiver; see FIG. 14. Aspects of actuator assemblies and/or handles described above may be utilized in the method steps described below. Where appropriate, reference may be made to components and systems that may be used in carrying out each step. These references are for illustration, and are not intended to limit the possible ways of carrying out any particular step of the method.

FIG. 14 is a flowchart illustrating steps performed in an illustrative method, and may not recite the complete process or all steps of the method. Although various steps of method 200 are described below and depicted in FIG. 14, the steps need not necessarily all be performed, and in some cases may be performed simultaneously or in a different order than the order shown.

While method 200 is specific to a hitch-mounted rack, aspects of the operation of a locking actuator knob described in the method may be applicable to use of other examples of a position-agnostic locking actuator knob as described above.

At step 202, the method includes attaching a rack to a vehicle. Sub-step 204 includes inserting a stinger into a hitch receiver. Examples of racks that may be attached to a vehicle include but are not limited to a hitch-mounted bike rack. For such a rack, the stinger may be the only connection to the vehicle. For some racks, other attachments such as straps or electrical connections may also be engaged in step 202.

Step 206 includes operating a securing mechanism, which may include sub-steps 208 of turning a handle of the rack and 222 of fixing the stinger in the hitch receiver. For example, a remotely actuated hitch mount device may be included in the stinger of a hitch-mounted rack. A handle of the device may be disposed at a rear end of the stinger, to extend or retract a friction brake element inside the hitch receiver of the vehicle. At sub-step 208 a user may rotate the handle such that at sub-step 222 the friction brake engages an interior surface of the hitch receiver to fix the stinger in the receiver.

Sub-steps 210-220 of step 208 may be optional, and vary according to the specific mechanism of the handle of the rack used. Sub-steps 228-232 and 240-242 may be similarly optional and dependent on the handle mechanism. In FIG. 14 and the following description the sub-steps are described as applicable for a position-agnostic locking actuator handle as described above, particularly a locking knob as described in Example A.

Sub-step 210 includes manually rotating a knob of the handle. In the present example the handle may include both a knob for manual rotation by a user and additional elements configured to allow position agnostic locking. The knob may be an exterior portion or grip of the handle, rotatable about a central axis of the handle.

Sub-step 212 includes rotating a shuttle with the knob. The knob may enclose a shuttle, pin, or other element configured for motion perpendicular to the central axis of the handle. That is, lateral or radial motion. The knob or other handle element may enclose, constrict, or contact the shuttle such that rotation of the knob results in rotation of the shuttle.

Sub-step 214 includes allowing a spring bias to urge the shuttle to engage a core structure. The shuttle may be spring-biased toward engagement with one or more openings in the core structure. In some examples, the core structure may be a surrounding transmission structure. In some examples, the shuttle may rotate around the core structure. In either example, sub-step 214 may include allowing radial translation of the shuttle toward the openings.

If the shuttle is not aligned with any opening of the core structure, sub-step 212 may be continued through sub-step 214 until the shuttle is aligned with one of the openings. Once aligned, the spring bias may urge at least a portion of the shuttle into the corresponding one of the openings.

Sub-step 216 again includes rotating the shuttle with the knob, as in sub-step 212. However with a portion of the shuttle received in an opening of the core structure, such rotation of the shuttle may result in rotation of the core structure as in sub-step 218. That is, the core may be rotated through contact of the shuttle with the core structure.

Sub-step 220 includes rotating an actuating shaft of the securing mechanism with the core. For example, the core structure may be fixed to, fastened to, connected to, or in contact with a bolt or other actuating shaft such that rotation of the core structure causes rotation of the shaft.

At step 224, the method includes locking the securing mechanism. In particular, sub-step 226 includes operating a lock assembly with a key. For example, a key may be turned to transition a lock assembly of the handle from an unlocked configuration to a locked configuration, thereby transitioning the handle from an unlocked mode to a locked mode.

In the locked mode, the securing mechanism may not be operable via the handle. For example, a manual interface portion, grip, or knob of the handle may rotate or otherwise move freely without acting on actuating elements of the securing mechanism.

Sub-step 228 includes moving a projection of the lock assembly. The projection may be rotated, translated or otherwise moved by the key as part of operation of the lock assembly. The projection may be configured to act on the shuttle of the handle. For example, the projection may extend into a recess of the shuttle and may be brought into or out of contact with one or more walls of the recess by the motion of sub-step 228.

Sub-step 230 includes disengaging the shuttle from the core with the projection. For example, motion of the projection in sub-step 228 may bring the projection into contact with the shuttle and further motion may urge the shuttle against the spring bias out of an opening of the core structure which the shuttle had been at least partially received in. That is, the projection may pull or push the shuttle out of contact with the core structure.

Sub-step 232 includes resisting the spring bias with the projection. For example, the projection may remain in contact with the shuttle and prevent radial translation of the shuttle toward the core structure and/or the openings of the core structure. In some examples, the shuttle may be held out away from a central structure, or in away from a surrounding structure.

At step 234, method 200 includes using the rack. For example, a user may unfold or open the rack and transport bicycles on the rack, using the vehicle. The user may also leave the rack attached to the vehicle between incidences of use, with the locked securing mechanism preventing unauthorized removal of the rack from the vehicle.

When the user desires to make an authorized removal of the rack, the method may proceed to step 236, which includes unlocking he securing mechanism. Similarly to step 226, sub-step 238 includes operating the lock assembly of the handle with the key. However at sub-step 238, the key may be turned to transition the handle from the locked mode back to the unlocked mode.

Similarly to sub-step 228, sub-step 240 includes moving the projection of the lock assembly. The projection may be rotated, translated or otherwise moved by the key as part of operation of the lock assembly, and may be moved in a direction opposite to sub-step 228. For example, the projection may be moved out of contact with the shuttle.

Similarly to sub-step 214, sub-step 242 includes allowing the spring bias to urge the shuttle toward the core. However, if the shuttle is not already in alignment with an opening of the core, the shuttle may contact an circumferential surface or flange of the core structure without being received into an opening or rotationally engaging the core structure.

At step 244, the method includes operating the securing mechanism and sub-step 246 includes turning the handle of the rack. Similarly to sub-step 208, sub-step 246 may include optional sub-steps 210-220. If the shuttle engaged the core at sub-step 242, the step may proceed from sub-step 216. Otherwise, at sub-step 212 the shuttle may be rotated across the circumferential surface or flange of the core structure until reaching an opening such that sub-step 214 may proceed.

Sub-step 248 includes releasing the stinger from the hitch receiver, and the securing mechanism may be operated in reverse, by turning the handle in an opposite direction. For example, the user may rotate the handle in sub-step 246 such that at sub-step 248 the friction brake moves out of contact with the hitch receiver. Optional sub-steps 210-220 may be performed similarly whichever direction the handle is turned, and whether the securing mechanism is operated to fix the stinger or release the stinger.

Finally, step 250 includes removing the rack from the vehicle, including removing the stinger from the hitch receiver at sub-step 252. Steps 202-250 may be repeated as desired for use of the rack. Optional sub-steps 210-220, 226-232, and 240-242 may also be used as part of other methods, to use, lock, and unlock an actuator handle for any actuating assembly.

### Illustrative Combinations and Additional Examples

This section describes additional aspects and features of locking actuator handles, presented without limitation as a series of paragraphs, some or all of which may be alphanumerically designated for clarity and efficiency. Each of these paragraphs can be combined with one or more other paragraphs, and/or with disclosure from elsewhere in this application, including the materials incorporated by reference in the Cross-References, in any suitable manner. Some of the paragraphs below expressly refer to and further limit other paragraphs, providing without limitation examples of some of the suitable combinations.
A0. An actuator for manually securing a connection between a first structure and a second structure, comprising:
a shaft having a rotational axis, a proximal end portion, and a distal end portion,
a core body mounted on the distal end portion of the shaft, the core body having an internal circular space and one or more circumferential recesses adjacent the circular space,
a handle assembly mounted on the distal end portion of the shaft, the handle assembly having an outer gripping portion connected to a lock carrying portion inside the internal circular space of the core body, wherein the gripping portion and lock carrying portion rotate together around the rotational axis of the shaft, and
a lock device engaging a spring biased pin inside the lock carrying portion of the handle assembly, wherein key operated rotation of the lock device drives translation of the pin out of the one or more circumferential recesses in the core body, disengaging linked synchronized rotation of the core body and the handle assembly around the rotational axis of the shaft.
A1. The actuator of paragraph A0, wherein the first structure is a hitch receiver mounted on the rear end of a vehicle, and the second structure is a hitch rack for carrying cargo.
A2. The actuator of paragraph A0 or A1, wherein the lock device is operable between a locked position and an unlocked position, the pin being freely spring biased into one of the one or more circumferential recesses of the core body when the lock device is in the unlocked position.
A3. The actuator of any of paragraphs A0-A2, wherein the core body has multiple circumferential recesses.
A4. The actuator of paragraph A3, wherein the core body has five circumferential recesses.
A5. The actuator of any of paragraphs A0-A4, wherein the proximal end portion of the shaft is threadingly engaged to a spacer portion that translates along the rotational axis when the shaft rotates.
B0. A locking handle for an actuator, comprising:
an exterior portion defining a rotational axis;
a sleeve rotationally engaged with the exterior portion, including an axial channel and a radial slot;
a lock core in the axial channel of the sleeve, including a projection extending into the radial slot;
a shuttle body at least partially disposed in the radial slot of the sleeve, having a recess receiving the projection of the lock core;
a gear structure rotationally engaged with the actuator and having a plurality of openings, each opening being shaped to receive a distal portion of the shuttle body;
wherein the shuttle body is biased to move radially outward from the sleeve.
B1. The locking handle of paragraph B0, wherein the axial channel of the sleeve is open to the radial slot.
B2. The locking handle of paragraph B0 or B1, wherein the exterior portion includes a grip.
B3. The locking handle of any of paragraphs B0-B2, wherein the shuttle body is spring-biased.
B4. The locking handle of paragraph B3, wherein a biasing spring extends from a rear wall of the radial slot of the sleeve into an opening in the shuttle body.
B5. The locking handle of any of paragraphs B0-B4, wherein the sleeve is in splined engagement with the exterior portion.
B6. The locking handle of any of paragraphs B0-B5, wherein the radial slot of the sleeve is substantially T-shaped, and shuttle body includes a pair of opposing projections.
B7. The locking handle of paragraph B6, wherein the opposing projections of the shuttle body engage the T-shaped radial slot of the sleeve to limit axial motion of the shuttle body.
B8. The locking handle of any of paragraphs B0-B7, wherein the projection of the lock core has a locked position and an unlocked position.
B9. The locking handle of paragraph B8, wherein the shuttle body has an engaged position in which the distal portion of the shuttle body is received in the one of the plurality of openings of the gear structure, and a disengaged position in which the shuttle body is entirely received in the sleeve.
B10. The locking handle of paragraph B9, wherein the projection of the lock core retains the shuttle body in the disengaged position, when in the locked position.
B11. The locking handle of paragraph B9 or B10, wherein the projection of the lock core is rotatable between the locked position and the unlocked position.
B12. The locking handle of paragraph B11, wherein rotation of the projection from the locked position to the unlocked position allows radial translation of the shuttle body from the disengaged position to the engaged position.
B13. The locking handle of paragraph B12, wherein radial translation of the shuttle body from the disengaged position to the engaged position is prevented by a circumferential flange of the gear structure until the shuttle body is aligned with an opening of the plurality of openings, the circumferential flange including the plurality of openings.
B14. The locking handle of any of paragraphs B11-B13, wherein rotation of the projection from the unlocked position to the locked position radially translates the shuttle body from the engaged position to the disengaged position.
B15. The locking handle of any of paragraphs B0-B14, wherein the gear structure is rotationally fixed to a member of an actuating mechanism.
B16. The locking handle of paragraph B15, wherein the member of the actuating mechanism is a bolt.
B17. The locking handle of paragraph B16, wherein the gear structure is molded over a head of the bolt.
B18. The locking handle of any of paragraphs B15-B17, wherein the actuation mechanism actuates a hitch mount retention device.
B19. The locking handle of any of paragraphs B0-B18, wherein the gear structure is a crown gear, the plurality of openings being tooth spaces of the gear.
B20. The locking handle of any of paragraphs B0-B19, wherein the locking handle has a locked mode in which the exterior portion rotates freely relative to the gear structure, and an unlocked mode in which rotation of the exterior portion causes rotation of the gear structure.
B21. The locking handle of any of paragraphs B0-B20, wherein the rotational axis defined by the exterior portion is a central axis of the handle, and the exterior portion is manually rotatable around the central axis.
C0. A locking handle for an actuator, comprising:
a manually rotatable exterior portion, rotationally engaged with a sleeve surrounding a lock core having a locked mode and an unlocked mode;
a shuttle body at least partially disposed in a radial slot of the sleeve and receiving a projection of the lock core;
a gear structure partially surrounding the sleeve, and rotationally engaged with the actuator;
wherein the shuttle body is disengaged from the gear structure when the lock core is in the locked mode, such that manual rotation of the exterior portion does not cause rotation of the actuator; and
wherein transitioning the lock core from the locked mode to the unlocked mode rotates the projection of the lock core, allowing a bias element to urge the shuttle body into an opening of the gear structure, such that manual rotation of the exterior portion causes rotation of the actuator.
D0. A method of using an actuator handle,
unlocking a lock core in a sleeve, to rotate a projection of the lock core out of contact with a shuttle body disposed in a radial slot of the sleeve;
allowing a bias element to urge the shuttle body radially outward into an opening in a surrounding gear structure;
rotating the sleeve with a manual grip of the actuator handle, to rotate the shuttle body and the gear structure.
D1. The method of paragraph D0, wherein the opening is one of a plurality of openings in a circumferential flange of the gear structure, and prior to the allowing a bias element step, further including:
allowing the bias element to urge the shuttle body radially outward until the shuttle body contacts a circumferential flange of the gear structure;
rotating the sleeve with the manual grip to rotate the shuttle body until the shuttle body is aligned with the opening in the gear structure.
D2. The method of paragraph D1, wherein the opening is in the circumferential flange of the gear structure.
D3. The method of any of paragraphs DO-D2, wherein the gear structure is rotationally fixed to a member of an actuating mechanism, and rotating the sleeve to rotate the gear structure includes rotating the member.
D4. The method of any of paragraphs DO-D3, wherein the sleeve is in splined engagement with the manual grip.
D5. The method of any of paragraphs DO-D4, further including locking the lock core to urge the shuttle body radially inward out of the opening in the gear structure by rotating the projection.
E0. An actuator assembly, comprising:
a shaft defining a rotational axis;
a transmission structure rotationally fixed to the shaft and having one or more openings;
a shuttle body spring biased toward engagement with the openings; and
a manually rotatable handle having an exterior portion enclosing the transmission structure and the shuttle body, and having a lock assembly operable to transition the handle between a locked mode and an unlocked mode.
E1. The actuator assembly of paragraph E0, wherein the handle is rotatable independent of the shaft in the locked mode, and rotation of the handle results in rotation of the shaft in the unlocked mode.
E2. The actuator assembly of paragraph E0 or E1, wherein the handle is rotatable independent of the shaft when the shuttle body is disengaged from the openings, and rotation of the handle results in rotation of the shaft when the shuttle body is engaged with one of the openings.
E3. The actuator assembly of any of paragraphs E0-E2, wherein the shuttle body is disengaged from the openings in the locked mode.
E4. The actuator assembly of any of paragraphs E0-E3, wherein the shuttle body is disengaged from the openings in the locked mode such that the handle is rotatable independent of the shaft, and the shuttle body is allowed to engage the openings in the unlocked mode such that rotation of the handle results in rotation of the shaft.
E5. The actuator assembly of any of paragraphs E0-E4, further including a sleeve rotationally engaged with the exterior portion, including an axial channel and a radial slot;
wherein the lock assembly is disposed in the axial channel of the sleeve, and the shuttle body is at least partially disposed in the radial slot of the sleeve, and is biased to move radially outward from the sleeve.
E6. The actuator assembly of any of paragraphs E0-E5, wherein the transmission structure has a plurality of openings, each opening being shaped to receive a distal portion of the shuttle body.
E7. The actuator assembly of paragraph E6, wherein the lock assembly includes a projection extending into the radial slot and the shuttle has a recess receiving the projection of the lock assembly.
E8. The locking handle of paragraph E7, wherein the locking handle has a locked mode in which the exterior portion rotates freely relative to the transmission structure, and an unlocked mode in which rotation of the exterior portion causes rotation of the transmission structure.
E9. The locking handle of paragraph E7 or E8, wherein the projection of the lock assembly is movable between a locked position and an unlocked position by operating the lock assembly, and
wherein the shuttle body has an engaged position in which the distal portion of the shuttle body is received in the one of the plurality of openings of the transmission structure, and a disengaged position in which the shuttle body is entirely received in the sleeve.
E10. The locking handle of paragraph E9, wherein the projection of the lock assembly retains the shuttle body in the disengaged position, when in the locked position.
E11. The locking handle of paragraph E9 or E10, wherein movement of the projection from the locked position to the unlocked position allows radial translation of the shuttle body from the disengaged position to the engaged position.
E12. The locking handle of any of paragraphs E9-E11, wherein movement of the projection from the unlocked position to the locked position radially translates the shuttle body from the engaged position to the disengaged position.
E13. The locking handle of any of paragraphs E7-E12, wherein the transmission structure is a crown gear, the plurality of openings being tooth spaces of the gear.
E14. The actuator assembly of any of paragraphs E0-E13, wherein the lock assembly is key-operated.
E15. The actuator assembly of any of paragraphs E0-E14, wherein rotation of the shaft actuates a hitch mount retention device.
F0. A locking apparatus comprising
A shaft defining a rotational axis, and having a distal end portion,
A handle connected to the distal end portion of the shaft, and
A key operated lock device contained inside the handle, having an unlocked position imparting a torsional linkage between the shaft and the handle, and a locked position disengaging the torsional linkage between the shaft and the handle.
F1. The apparatus of paragraph F0, wherein the rotational axis of the shaft passes through the key operated lock device.
F2. The apparatus of paragraph F0 or F1, wherein the key operated device is centered inside the handle.
F3. The apparatus of any of paragraphs F0-F2, wherein the key operated lock device stays torsionally fixed relative to the handle in both locked and unlocked positions.
F4. The apparatus of any of paragraphs F0-F3, wherein the key operated lock device stays torsionally fixed relative to the shaft in both locked and unlocked positions.
F5. The apparatus of any of paragraphs F0-F4, wherein the lock device is symmetrically located relative to the rotational axis of the shaft.
F6. The apparatus of any of paragraphs F0-F5, wherein the lock device is symmetrically located relative to a circumference of the handle.
F7. The apparatus of any of paragraphs F0-F6, wherein the torsional linkage includes a pin spring biased toward a slot.
F8. The apparatus of paragraphs F7, wherein the lock device disengages the pin from the slot when the lock device is transitioned to the locked position.
F9. The apparatus of paragraphs F7 or F8, wherein the lock device allows the pin to engage the slot when the lock device is transitioned to the unlocked position.

### Advantages, Features, and Benefits

The different examples of the actuator assembly and locking handle described herein provide several advantages over known solutions for locking a rotating handle. For example, illustrative examples described herein allow position agnostic locking.

Additionally, and among other benefits, illustrative examples described herein allow one-handed operation by separating lock and handle use-motions.

Additionally, and among other benefits, illustrative examples described herein use a radially symmetric design, minimizing handle diameter and allowing greater torque output for faster and more effective actuation.

Additionally, and among other benefits, illustrative examples described herein are useful in any actuator system operating on manual rotational input.

No known system or device can perform these functions, particularly in a compact, lightweight form. Thus, the illustrative examples described herein are particularly useful for hitch-mounted bike racks. However, not all examples described herein provide the same advantages or the same degree of advantage.

### CONCLUSION

The disclosure set forth above may encompass multiple distinct examples with independent utility. Although each of these has been disclosed in its preferred form(s), the specific examples thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. An actuator assembly, comprising:
a shaft defining a rotational axis;
a handle, including:
a transmission structure rotationally fixed to the shaft and having one or more openings,
a shuttle spring-biased toward engagement with the openings,
a lock assembly operable to transition the handle between a locked mode and an unlocked mode, and
a manually rotatable handle body enclosing the transmission structure, the shuttle, and the lock assembly;
wherein the handle body is rotatable independent of the shaft in the locked mode, and rotation of the handle body results in rotation of the shaft in the unlocked mode.

2. The actuator assembly of claim 1, wherein the shuttle is disengaged from the openings in the locked mode.

3. The actuator assembly of claim 1, further including a sleeve rotationally engaged with the exterior portion, including an axial channel and a radial slot;
wherein the lock assembly is disposed in the axial channel of the sleeve, and the shuttle is at least partially disposed in the radial slot of the sleeve, and is biased to move radially outward from the sleeve.

4. The actuator assembly of claim 3, wherein the transmission structure has a plurality of openings, each opening being shaped to receive an end portion of the shuttle.

5. The actuator assembly of claim 3, wherein the lock assembly includes a projection extending into the radial slot and the shuttle has a recess receiving the projection of the lock assembly.

6. The actuator assembly of claim 1, wherein the lock assembly is key-operated.

7. The actuator assembly of claim 1, wherein rotation of the shaft actuates a hitch mount device.

8. A locking handle for an actuator, comprising:
an exterior portion manually rotatable about a central axis;
a sleeve rotationally engaged with the exterior portion, including an axial channel and a radial slot;
a lock assembly in the axial channel of the sleeve, including a projection extending into the radial slot;
a shuttle at least partially disposed in the radial slot of the sleeve, having a recess receiving the projection of the lock assembly; and
a transmission structure rotationally engaged with the actuator and having a plurality of openings, each opening being shaped to receive an end portion of the shuttle;
wherein the shuttle is biased to move radially outward from the sleeve.

9. The locking handle of claim 8, wherein the locking handle has a locked mode in which the exterior portion rotates freely relative to the transmission structure, and an unlocked mode in which rotation of the exterior portion causes rotation of the transmission structure.

10. The locking handle of claim 8, wherein the projection of the lock assembly is movable between a locked position and an unlocked position by operating the lock assembly, and
wherein the shuttle has an engaged position in which the end portion of the shuttle is received in the one of the plurality of openings of the transmission structure, and a disengaged position in which the shuttle is entirely received in the sleeve.

11. The locking handle of claim 10, wherein the projection of the lock assembly retains the shuttle in the disengaged position, when in the locked position.

12. The locking handle of claim 10, wherein movement of the projection from the locked position to the unlocked position allows radial translation of the shuttle from the disengaged position to the engaged position.

13. The locking handle of claim 10, wherein movement of the projection from the unlocked position to the locked position radially translates the shuttle to the disengaged position.

14. The locking handle of claim 8, wherein the transmission structure is a crown gear, the plurality of openings being tooth spaces of the gear.

15. The locking handle of claim 8, wherein the transmission structure is rotationally fixed to a member of an actuating mechanism.

16. A method of using an actuator handle,
operating a lock assembly in a handle body to rotate a projection of the lock assembly out of contact with a shuttle;
allowing a bias element to urge the shuttle radially outward into an opening in a surrounding transmission structure; and
rotating the handle body to rotate the shuttle and the transmission structure.

17. The method of claim 16, wherein the unlocking step can be performed with the handle body in any position.

18. The method of claim 16, wherein the transmission structure is rotationally fixed to a member of an actuating mechanism, and rotating the handle body to rotate the transmission structure includes rotating the member.

19. The method of claim 16, wherein the opening is one of a plurality of openings in a circumferential flange of the transmission structure, and
prior to the allowing a bias element step, further including:
allowing the bias element to urge the shuttle radially outward until the shuttle contacts a circumferential flange of the transmission structure;
rotating the handle body to rotate the shuttle until the shuttle is aligned with one of the plurality of openings in the transmission structure; and
allowing the bias element to urge the shuttle radially outward into the corresponding one of the plurality of openings in the transmission structure.

20. The method of claim 16, further including operating the lock assembly to urge the shuttle radially inward, out of the opening in the transmission structure, by rotating the projection.
